(19) United States
(12) Patent Application Publication
(10) Pub. No.: US 2005/0280580 A1
(43) Pub. Date: Dec. 22, 2005

(54) Ultra wide band planar monopole trapezoidal antenna

(75) Inventor: Ding-Fu Lin, Wugu Township (TW)

Correspondence Address: HDSL, 4331 STEVENS BATTLE LANE, FAIRFAX, VA, 22033, US

(73) Assignee: Ding-Fu Lin

(21) Appl. No.: 11/066,148

(22) Filed: Feb. 25, 2005

(30) Foreign Application Priority Data
Jun. 21, 2004 (TW) 93117902

(51) Int. Cl. H01Q 1/38

(52) U.S. Cl. 343/700 MS; 343/846

(57) ABSTRACT

An ultra wide band planar monopole trapezoidal antenna is provided. The antenna includes a radiation element and a transmission element. Both the radiation element and the transmission element are formed on a printed circuit board. The transmission element is connected to the radiation element. The radiation element is made of electrically conductive material, which includes an upper base and a lower base parallel to the upper base. The upper base and the lower base are connected to form two side portions. The lower base of the radiation element is parallel to the grounded surface of the transmission element, thereby forming a tunable feedgap.

### BACKGROUND OF THE INVENTION

The present invention relates generally to an ultra wide band planar monopole trapezoidal antenna, and more particularly to an ultra wide band antenna that is manufactured by printing and is operated within the frequency range of 3.1 GHz and 10.6 GHz. The ultra wide band antenna is advantageous in that it is light in weight, small in size, low cost, easy to fabricate, high performance and highly integrated, so as to provide ultra wide band (UWB) communication and for use in a measuring system.

Wireless communications are primarily divided into 802.11a/b/g wireless network and the bluetooth technology. The wireless network of 802.11b was primarily used for commercial purposes before, but is gradually becoming a standard device for portable computers, which becomes a home application.

UWB is one of the most recently developed wireless communication technologies. It is a technology for short distance transmission, which is extraordinary high in speed and low in power consumption. If one compares the UWB and the 802.11a technology, one can find that the UWB technology is better than the 802.11a technology in that the transmission speed is higher and the power consumption is lower.

A UWB antenna requires simultaneous satisfaction of the input impedance and the radiation pattern being controlled within a certain frequency range. However, an antenna that has both of the above characteristics is not commonly seen. As shown in FIG. 1, a trapezoidal monopole antenna is illustrated. The trapezoidal monopole antenna is disposed on a broad ground surface, wherein W1, W2 denote the lower base and the upper base of the trapezoid, while L denotes the height of the trapezoid. The bandwidth is between 1.07 GHz and 12.2 GHz, which can reach a 10:1 relative bandwidth. However, the high frequency radiation pattern is not better than the low frequency radiation pattern, and such three dimensional structure requires a broad ground surface. It is therefore difficult to fabricate and to lower the cost. The broad ground surface requirement and the heavier antenna unit hinders its application to mobile wireless communications.

### BRIEF SUMMARY OF THE INVENTION

One objective of the present invention is to provide an ultra wide band planar monopole trapezoidal antenna that can solve the drawbacks described above. The antenna of the present invention is fabricated by employing a two dimensional planar printing technology, which can easily be adapted for use in mobile communications.

In order to achieve the above and other objectives, an ultra wide band planar monopole trapezoidal antenna is provided. The antenna includes a radiation element and a transmission element. Both the radiation element and the transmission element are formed on a printed circuit board. The transmission element is connected to the radiation element. The radiation element is made of electrically conductive material, which includes an upper base and a lower base parallel to the upper base. The upper base and the lower base are connected to form two side portions. The lower base of the radiation element is parallel to the grounded surface of the transmission element, thereby forming a tunable feedgap.

### BRIEF DESCRIPTION OF THE DRAWINGS

FIG. 1 is a three dimensional perspective view of a conventional trapezoidal antenna.

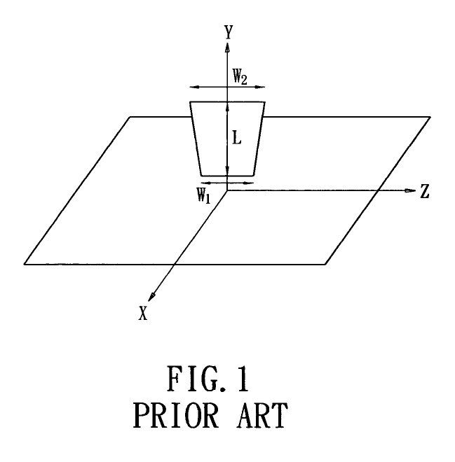

FIG. 2 is a sectional view of an ultra wide band planar monopole trapezoidal antenna, in accordance with one embodiment of the present invention.

FIG. 3 illustrates a diagram of return loss versus frequency of the ultra wide band planar monopole trapezoidal antenna, in accordance with one embodiment of the present invention.

FIG. 4 to FIG. 6 are sectional views of an ultra wide planar monopole trapezoidal antenna, in accordance with another embodiment of the present invention.

### DETAILED DESCRIPTION OF THE INVENTION

In order to better understanding the features and technical contents of the present invention, the present invention is hereinafter described in detail by incorporating with the accompanied drawings. However, the accompanied drawings are only for the convenience of illustration and description, no limitation is intended thereto.

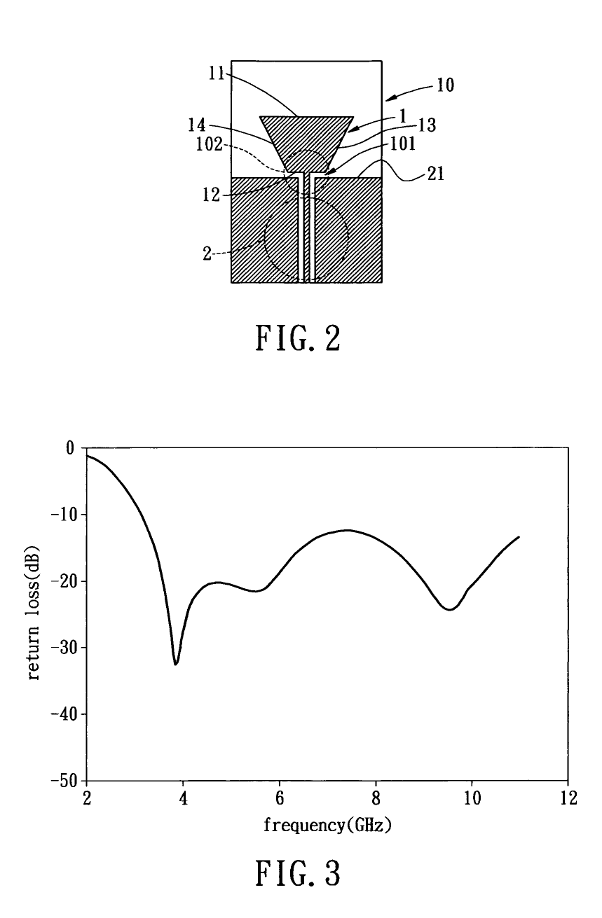

Referring to FIG. 2, an ultra wide band planar monopole trapezoidal antenna of the present invention is illustrated. As shown, the ultra wide band planar monopole trapezoidal antenna that is manufactured by employing a planar printing technology is primarily used in a frequency range of 3.1 GHz and 10.6 GHz, so as to provide ultra wide band (UWB) communication and for use in a measuring system.

The ultra wide band planar monopole trapezoidal antenna mentioned above is formed on a printed circuit board 10 by etching, which includes a radiation element 1 and a transmission element 2.

The aforementioned transmission element 2 is used for transmitting signals to the radiation element 1, so as to send out the signal through the radiation element 1. The aforementioned radiation element 1 includes an upper base 11 and a lower base 12. The upper base 11 and the lower base 12 include equilateral or unequilateral side portions 13, 14 formed thereon.

The transmission element 2 is a coplanar waveguide (CPW) structure, which forms a grounded surface 21 parallel to the lower base 12 of the radiation element 1. There is also formed a tunable feedgap 101. When the tunable feedgap 101 is between the range of 0λ and 0.4λ, the antenna can have a better bandwidth, where λ is the wavelength of the central frequency of the designed frequency band.

In addition, a feed point 102 is formed between the tunable feedgap 101, the radiation element 1 and the transmission element 2, so as to feed the signal to be transmitted.

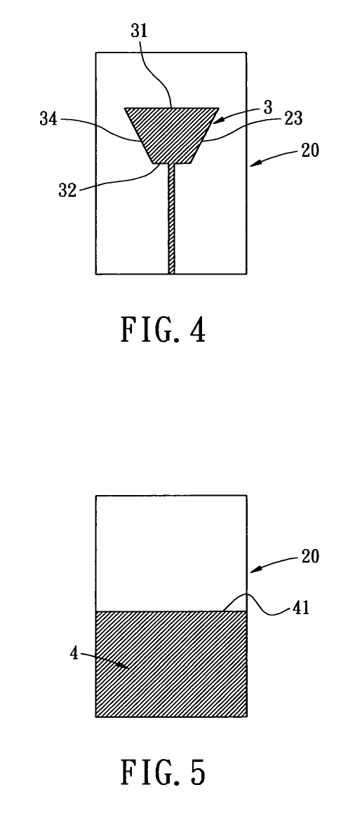

Referring to FIG. 2 and FIG. 3, the ultra wide band planar monopole trapezoidal antenna of the present invention and a return loss versus frequency diagram are respectively illustrated. As shown, the choice of the tunable feed gap 101 is the most important factor affecting the band width when designing the ultra wide band planar monopole trapezoidal antenna of the present invention. According to an experimental measurement, the antenna has a pretty good bandwidth when the tunable feedgap is in the range of 0λ to 0.4λ. As shown in the resultant measurement, the return loss is below −10 dB for frequencies between 3.2 GHz and 10.2 GHz, which has a relative band with of 3.19:1.

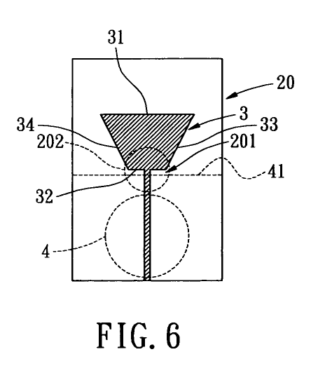

Referring to FIG. 4 to FIG. 6, an ultra wide band planar monopole trapezoidal antenna in accordance with another embodiment of the present invention is illustrated. As shown, the ultra wide band planar monopole trapezoidal antenna is formed on a printed circuit board 20 by etching, which includes a radiation element 3 and a transmission element 4.

The aforementioned transmission element 4 is used for transmitting signals to the radiation element 3, so as to send out the signal through the radiation element 3. The aforementioned radiation element 3 includes an upper base 31 and a lower base 32. The upper base 31 and the lower base 32 include equilateral or unequilateral side portions 33, 34 formed thereon.

The transmission element 4 is a microstripline structure, which forms a grounded surface 41 parallel to the lower base 32 of the radiation element 3. There is also formed a tunable feedgap 201. When the tunable feedgap 201 is between the range of 0λ and 0.4λ, the antenna can have a better bandwidth, where λ is the wavelength of the central frequency of the designed frequency band.

In addition, a feed point 202 is formed between the tunable feedgap 201, the radiation element 3 and the transmission element 4, so as to feed the signal to be transmitted.

Heretofore, various embodiments of the ultra wide band planar monopole trapezoidal antenna of the present invention have been described in detailed. The antenna of the present invention is advantageous in that the fabrication cost is lower, the fabrication process is easier, and the size is smaller. Furthermore, the antenna of the present invention is still advantageous in that the radiation pattern is isotropic, and the antenna is highly integrated.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

1. An ultra wide band planar monopole trapezoidal antenna, comprising:
a radiation element and a transmission element, both formed on a printed circuit board, wherein the transmission element is connected to the radiation element;
the radiation element made of electrically conductive material comprises a upper base and a lower base parallel to the upper base, the upper base and the lower base being connected, thereby forming a closed shape with two side portions;
the lower base of the radiation element being parallel to the grounded surface of the transmission element, thereby forming a tunable feedgap.

2. The antenna as recited in claim 1, wherein the side portions are equilateral.

3. The antenna as recited in claim 1, wherein the side portions are unequilateral.

4. The antenna as recited in claim 1, wherein the tunable feedgap is between 0λ to 0.4λ, where λ is the wavelength of the central frequency of the designed frequency band.

5. The antenna as recited in claim 1, wherein the transmission element comprises a microstripline.

6. The antenna as recited in claim 1, wherein the transmission element comprises a coplanar waveguide.

7. The antenna as recited in claim 1, wherein the transmission element comprises a stripline.
